(19) United States
(12) Patent Application Publication
(10) Pub. No.: US 2006/0064330 A1
(43) Pub. Date: Mar. 23, 2006

(54) Insurance contract support system

(76) Inventors: Akira Sumino, Tokyo (JP); Toshinori Hanaoka, Chiba (JP)

Correspondence Address: WENDEROTH, LIND & PONACK, L.L.P., 2033 K STREET N. W., SUITE 800, WASHINGTON, DC, 20006-1021, US

(21) Appl. No.: 10/515,385

(22) PCT Filed: May 22, 2003
(86) PCT No.: PCT/JP03/06410

§ 371 Date: Nov. 23, 2004

(30) Foreign Application Priority Data
May 24, 2002 (JP) 2002-150174

(51) Int. Cl. G06Q 40/00

(52) U.S. Cl. 705/4

(57) ABSTRACT

This invention seeks to provide an insurance contract support system, which enables an insurance agent or solicitor to invite a customer to take out an insurance policy and negotiate an insurance contract at any time and any place, using a device making no requirement for maintenance on the agent or solicitor.

To attain the object as described above, the insurance contract support system of the invention comprises a management device 2 to which each of terminal devices 3 are connected through a network 4. The management device 2 stores insurance-related information relevant to insurance sales and acquires terminal discriminating information of the specified or unspecified terminal device 3 being accessed thereto, so as to allow any of the terminal devices accessed to the management device to make effective use of the insurance-related information, consequently to assist the routine clerical work for operating insurance contract.

### TECHNICAL FIELD

This invention relates to a system associated with procedures involved in an insurance contract.

### BACKGROUND ART

Insurance sales for getting an insurance contract have been hitherto conducted while providing a face-to-face explanation of a sales representative of an insurance company (insurance solicitor) to a customer. However, the insurance sales have been increasing through the spread of the Internet in recent years. Electronic commerce has the advantage that a customer can use freely at any time without feeling trouble with talking to an insurance solicitor and can ensure a beneficial result for the insurance concern to reduce the cost required for preparing various document papers such as a contract document because the necessary items for insuring can be filled in an insurance application form on a screen display. On the other hand, the benefit of face-to-face selling is that a customer can be made fully aware of articles of commerce or sufficiently take the advice of the insurance solicitor. Furthermore, the face-to-face sales for damage insurance have been often made through insurance agents or brokers hired by more than one insurance administration company, getting the convenience of offering discriminative services tailored to each insurance company. Even though the electronic commerce has been increasing with the Internet under most of these circumstances, face-to-face selling for contract of insurance has been still used at a high ratio.

The insurance agent or solicitor often invited a customer to take out an insurance policy while showing catalogues or brochures for insurance goods to the customer. When getting the insurance contract, the insurance agent prepared the necessary application forms for the contract of insurance so as to let the customer fill in the application forms. In a case of handling car insurance, the insurance agent or solicitor had to carry an explanatory booklet for calculating an insurance premium on the basis of an appraisal value of a subject vehicle for the purpose of canvassing the customers' homes for applications of insurance. The explanatory booklet for insurance contract is too heavy and bulky to carry around. In order to reduce the burden of the insurance solicitor, there have been developed a system for storing the contents of the explanatory booklet for insurance and the necessary application forms in a memory of a portable computer.

As one example, Japanese Patent Application Publication No. 2000-148844A1 discloses a system using a combination of a portable terminal device storing a dedicated program exclusively for the insurance agent and a printer to eliminate the use of brochures and booklet for explaining insurance policy as noted above and application forms. The portable terminal device in the aforementioned conventional system is a laptop personal computer previously storing the necessary data such as an insurant premium tariff and a schedule of appraisal values of vehicles in various situations in the form of tables, and calculating programs for deciding insurant premiums and appraisal values of vehicles in accordance with various conditions on the basis of input data. The insurance agent or solicitor goes on a visit to a customer with the portable terminal device in his/her hand, so that the necessary insurance application forms can be prepared there with the aid of the previously stored data and programs while inputting personal information data and vehicle information data into the terminal device.

However, the insurant premium tariff is liable to vary with insurance rates and revision of insurance goods, which are often redefined at regular periods, and a standard price list of vehicles, which is frequently changed with new-car sales. Hence, the data stored in the portable terminal device described in Japanese Patent Application Publication No. 2000-148844 must be reinstalled whenever the insurant premium tariff or other information is changed, requiring the insurance agent of a huge amount of clerical work for maintaining the data stored in the terminal device and updating the data.

Furthermore, the conventional system requires the insurance agent or solicitor to carry the brochures or catalogues showing the insurance goods and insurance application forms all the times. Namely, when the insurance agent or solicitor meets the customer without the essential articles for insurance sales, the agent or solicitor might miss an opportunity of capture a new insurance contract.

In the light of the problems in the conventional system, the present invention seeks to provide an insurance contract support system, which enables an insurance agent or solicitor to invite a customer to take out an insurance policy and negotiate an insurance contract at any time and any place, using a device making no requirement for maintenance on the agent or solicitor.

### DISCLOSURE OF THE PRESENT INVENTION

To attain the object as described above according to the present invention, there is provided an insurance contract support system as noted below.

The insurance contract support system according to the present invention comprises a management device and a terminal device connected through a network, which management device includes an insurance-related information database, a terminal discriminating information acquisition means for gaining information for discriminating the type of the terminal device connected to the management device and specified or unspecified by the management device, and an application assist means for issuing insurance-related information for making the management device available to the terminal device of any type in accordance with terminal discriminating information obtained by the terminal discriminating information acquisition means.

According to the system, the management device becomes accessible from the terminal device of any type on the basis of the terminal discriminating information given from the management device to allow the terminal device to use the insurance-related information, so that even an unspecified terminal device can be used for conducting insurance services. The management device has the insurance-related information database for giving required insurance-related information to the terminal device connected to the management device. Updating and/or change of the insurance-related information can be collectively implemented on the management device, thus to eliminate the need for doing maintenance on each terminal device, which is needed for the conventional terminal device. The application assist means has another function of assisting the routine clerical work of making up an estimate for insurance expense and making inquiries about insurance information.

Further, the management device in the system of the invention is provided with an information compensation means for compensating information to be given to the terminal device on the basis of the terminal discriminating information from the terminal discriminating information acquisition means, so as to transmit the application form from the application assist means to the terminal device through the information compensation means.

With the information compensation means, the information given to the terminal device is corrected on the basis of the terminal discriminating information for the terminal device. The information given to the terminal device includes not only the insurance-related information but also an instruction form to ask for entering information data into the terminal device. That is, one set of information data suffices for the management device because the information data submitted from the management device are compensated with the information compensation means in accordance with the terminal device being connected to the management device. Namely, a number of sets of information data for various types of terminal devices are not needed to be stored in the management device, so that only one set of information data may be updated when the necessity arises, consequently to lighten the burden imposed on the management device.

The management device in the system according to the invention may be provided with a terminal discriminating database storing the aforementioned terminal discriminating information in correlation with displaying ability of description language of the terminal device, so that the terminal discriminating information to be sent to the terminal device is compensated being collated with the data stored in the terminal discriminating database on the basis of the indicative ability sought in the terminal discriminating database.

With the terminal discriminating database previously storing the terminal discriminating information for specified or unspecified terminal devices accessible to the management device in correlation with the indicative ability of description language, the information data to be submitted to the terminal device on the basis of the terminal discriminating information acquired when connecting any terminal device to the management device can be compensated properly.

Further, the management device in the system of the invention may be provided with a contract conclusion means for concluding an insurance contract applied from the terminal device.

With the contract conclusion means, the applied insurance contract can be effected on the terminal device.

The management device in the system of the invention may be further provided with a connection information acquisition means for acquiring connection information indicative of connecting conditions between the management device and the terminal device, and an authentication means for authenticating the terminal device being accessed to the management device on the basis of the connection information to determine an authentication level.

In the system including the connection information acquisition means and authentication means, reliability and security of the connection between the management device and the terminal device can be recognized by determining the authentication level on the terminal device being accessed to the management device on the basis of the connection information. This is intended to avoid the risk posed by the management device capable of being accessed by the unspecified or specified terminal device, which possibly causes leakage of the insurance-related information given from the management device to the terminal device and is cheated according to the circumstances of connection between the management device and the terminal device.

The application assist means of the management device in the system according to the invention has a functional sphere variable with the authentication level determined by the authentication means.

The extent of providing the information by the management device to the terminal device by the aid of the application assist means is can be limited according to the authentication level. Consequently, the security level of the system can be changed with the authentication level.

The connection information obtained by the connection information acquisition means may contain agent authentication information for distinguishing whether a user using a terminal device being accessed to the management device is authenticated or not

With the connection information containing the agent authentication information, the authentication level can be determined according to the agent authentication information indicative of which insurance agent (insurance salesperson) accesses the management device.

Alternatively, the connection information obtained by the connection information acquisition means may contain terminal authentication information for distinguishing whether a terminal device being accessed to the management device is authenticated or not

With the connection information containing the terminal authentication information, the authentication level can be determined according to the agent authentication information indicative of which terminal device accesses the management device.

Alternatively, the connection information obtained by the connection information acquisition means may contain location authentication information for distinguishing whether a location from where a terminal device is accessed to the management device is authenticated or not.

With the connection information containing the location authentication information, the authentication level can be determined according to the agent authentication information indicative of the location from where the terminal device accesses the management device.

The application assist means in the insurance contract support system of the invention may assist browsing of the insurance-related information with the terminal device having the agent authentication information acquired by the connection information acquisition means.

With this system, the insurance-related information cannot be browsed if the agent authentication information is not acquired by the connection information acquisition means in the management device.

The application assist means in the insurance contract support system of the invention may assist browsing of the insurance-related information with the terminal device having both the agent authentication information and the terminal authentication information acquired by the connection information acquisition means.

With this system, the insurance-related information cannot be browsed if both the agent authentication information and the terminal authentication information are not acquired by the connection information acquisition means in the management device.

The insurance-related information database in the insurance contract support system of the invention may contain a plurality of pieces of insurance-related information in accordance with the types of the available terminal devices so as to submit a corresponding one of pieces of insurance-related information to the terminal device based on the terminal discriminating information through the application assist means.

With this system using the plurality of pieces of insurance-related information predetermined according to specified and unspecified terminal devices, any terminal device can be used for the routine clerical work for operating insurance contract.

In the insurance contract support system of the invention, the terminal device may be provided with a dedicated adapter connection means for permitting a dedicated adapter to automatically connect the terminal device to the management device for transmitting the terminal authentication information assigned by an insurance company to the terminal device regardless of whether the terminal device is specified or unspecified. The management device in this system also includes the insurance-related information database storing the insurance-related information associated with insurance contract services of the insurance company and the application assist means for transmitting the insurance-related information available to the terminal device in accordance with the terminal authentication information issued from the terminal device and assisting the routine clerical work for operating insurance contract.

With this system, the terminal device can be automatically connected to the management device merely by plugging the dedicated adapter carried in the hand of the insurance salesperson or the like into the terminal device without effecting any specific operation, so that the terminal authentication information can be automatically transmitted to the terminal device even unspecified. Thus, the management device issues the insurance-related information in accordance with the given terminal authentication information to assist the routine clerical work for operating insurance contract.

### BRIEF DESCRIPTION OF THE DRAWINGS

FIG. 1 is a block diagram showing an embodiment (1) of an insurance contract support system.

FIG. 2 is a detailed block diagram showing the embodiment (1) of an insurance contract support system.

FIG. 3 is a detailed block diagram showing the embodiment (1) of an insurance contract support system.

FIG. 4 is a flow chart of the operation of a first working example 1.

FIG. 5 is a flow chart of the operation of the first working example 1.

FIG. 6 illustrates a screen-displayed example on a terminal device of the insurance contract support system.

FIG. 7 illustrates a screen-displayed example on a terminal device of the insurance contract support system.

FIG. 8 illustrates a screen-displayed example on the terminal device of the insurance contract support system.

FIG. 9 illustrates a screen-displayed example on the terminal device of the insurance contract support system.

FIG. 10 illustrates a screen-displayed example on the terminal device of the insurance contract support system.

FIG. 11 is a flow chart of the operation of a second working example 2.

FIG. 12 illustrates a screen-displayed example on the terminal device of the insurance contract support system.

FIG. 13 illustrates a screen-displayed example on the terminal device of the insurance contract support system.

FIG. 14 illustrates a screen-displayed example on the terminal device of the insurance contract support system.

FIG. 15 is a flow chart of the operation of a third working example 3.

### BEST MODE FOR CARRYING OUT THE INVENTION

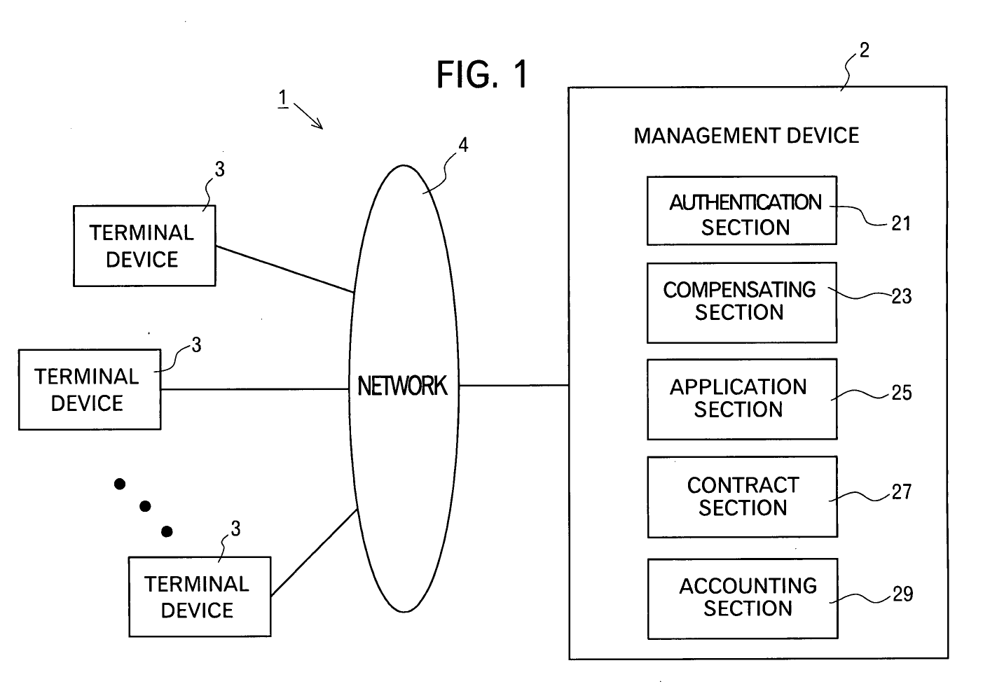

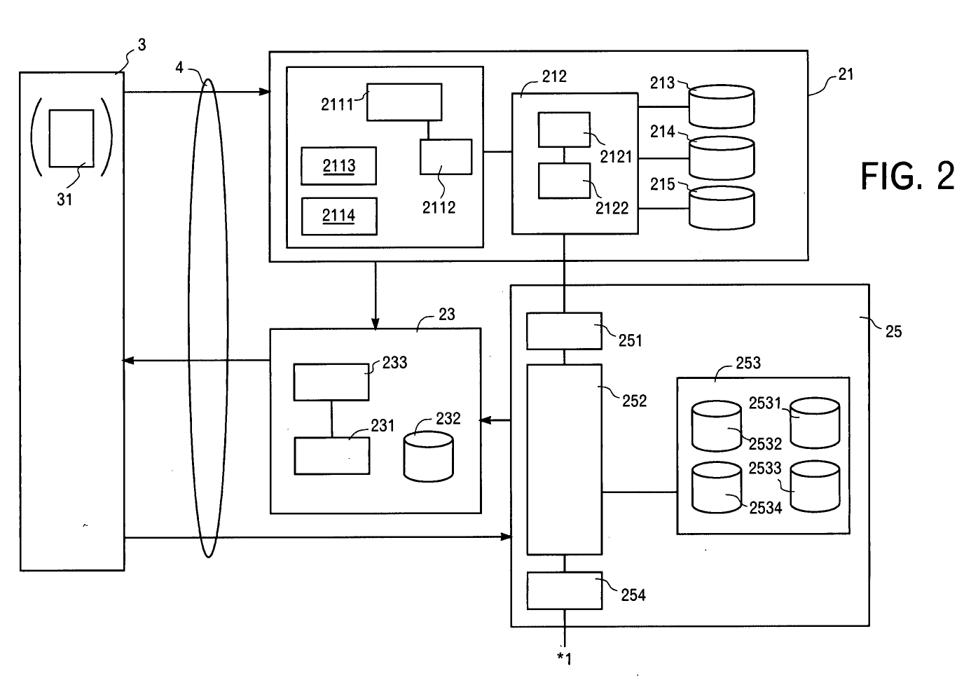

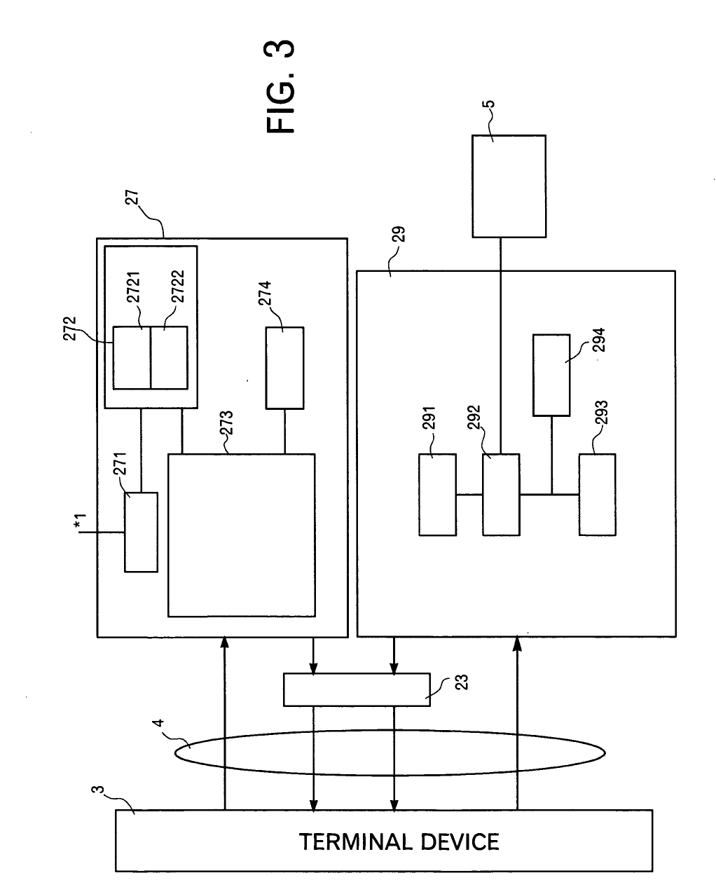

One embodiment of the insurance contract support system according to the present invention will be described hereinafter with reference to the accompanying drawings. FIG. 1 is a block diagram showing a first embodiment (1) of an insurance contract support system, and FIGS. 2 and 3 are detailed block diagrams showing the first embodiment (1) of the insurance contract support system. FIGS. 2 and 3 continue to each other at the point “*1” in the drawings.

The insurance contract support system 1 in the embodiment (1) of the invention comprises a management device 2 to which each of terminal devices 3 are connected through a network 4.

An aspect in which the system of the invention is applied to services of auto insurance, which is one of damage insurances, will be described herein by way of example, but this invention may be applied to any other life and nonlife insurance service business including fire insurance and accident insurance.

The management device 2 essentially has an input and output function, recording function, communication function, calculation function and so on. It may be formed of a mainframe computer, work-station computer or personal computer operable in collaboration with other computers as a general manner. Alternatively, the management device 2 may of course be composed from a combination of a plurality of servers and terminal devices or devices, and connected to external database systems according to need. The management device 2 is installed in an insurance company and connected to a host computer of the insurance company.

The terminal device 3 essentially has an input and output function, recording function, communication function, display function and so on. It is provided with a button means, touch panel, key board and/or mouse for fulfilling the input and output function. For the display function (display screen), there may be used LCD, CRT or the like. The terminal device may be a personal computer, handheld mobile terminal (personal digital assistant; PDA), cell phone, fixed-line phone, household appliance (television, refrigerator, etc.), car navigation system, game console and so forth. The terminal device 3 is used at the option of a user, sales representative of an insurance agent, that is, there may be used a terminal device installed in an insurance shop, a private personal computer owned by the sales representative of the insurance agent or the customer, or a terminal device equipped at an Internet cafe or a hotel.

The network 4 includes a communication system for Internet or other communication means.

Next, the formation of the management device 2 will be explained here. The management device 2 comprises an authentication section 21 for determining an authentication level based on the connection information of the terminal device 3 being accessed to the management device 2, an compensating section 23 for correcting the connection information of the terminal device 3 accessed to the management device 2, an application section 25 for applying for insurance policy, a contract section 27 for signing insurance contract, and an accounting section 29 for accounting the signed insurance contract.

First, the compensating section 23 will be explained. The compensating section 23 includes an information compensation means 231 for compensating information assigned to the terminal devices 3 in accordance with the displaying ability of each of the terminal devices. The compensating sections 23 are illustrated diversely in FIGS. 2 and 3 for convenience of explanation, but these are equivalent to each other. When the information is transmitted from the management device 2 to the terminal device 3, it is necessarily compensated by the information compensation means 231.

The compensating section 23 includes a terminal discriminating database 232 storing terminal discriminating information for discriminating the type of the terminal device 3 in correlation with displaying ability of description language of the terminal device 3, and a terminal discriminating information acquisition means 233 which acquires terminal discriminating information of the terminal device 3 being accessed thereto. The information compensation means 231 verifies the acquired terminal discriminating information with the terminal discriminating database 232 to compensate and transmit the terminal discriminating information in accordance with the displaying ability of the terminal device 3.

Since the terminal device 3 may choose to be identified or not be identified in this system of the invention, it may be of any personal computer, portable terminal or personal digital assistant (PDA), cell phone, land phone, digital consumer electronics, car navigation equipment, game machine or the like. Thus, the terminal devices are different in displaying ability (description language, function of a browser, display screen size, etc.) For example, there are various description languages such as Compact-HTML, HDML, MML and WML for cell phones, and various manners for displaying information data on the cellphone's screen, which are different in line number, character number, and color. Thus, various data on displaying ability for a variety of terminal devices are previously memorized on the terminal discriminating database 232 in correlation with the terminal discriminating information. Consequently, only one set of information (contents) suffices for various terminal devices to display the given information on the displays of the respective terminal devices because it is compensated for each of the terminal devices with the compensating section 23, unlike the conventional system of this kind necessitating a plurality of sets of information (contents) for various terminal devices.

The terminal discriminating information is for discriminating the type of the terminal device 3 and is automatically acquired by the management device 2 when the terminal device 3 is connected to the management device 2. In case of accessing to the management device 2 by using a cell phone, the acquisition of the terminal discriminating information enables discrimination of the type of a cell phone connected to the management device through a cellphone provider (carrier). In case of accessing to the management device by using a portable terminal such as a personal digital assistant (PDA) or personal computer, the type and version of browser installed in the portable terminal can be discriminated. Of course, a next-generation IPv6 may be used for discriminating the kind of home information appliances.

Next, the authentication section 21 will be explained. The authentication section 21 includes a connection information acquisition means 211 for obtaining the connection information indicative of the conditions under which the terminal device 3 is connected to the management device 2, an authentication means 212 for authenticating of the terminal device on the basis of the connection information to determine an authentication level, and various database units for collation of the connection information on the authentication means 212. The database units may be disposed outside the management device 2.

The connection information acquired by the connection information acquisition means 211 contains terminal authentication information for authenticating the terminal device and agent authentication information for authenticating an insurance agent appointed by an insurance company. If location authentication information for authenticating a location at which the terminal device can be referred to, the authentication level can be more increased. Namely, the connection information enables the management device 2 to recognize the place from which the terminal device 3 accesses to the management device 2. Since any type of terminal system or personal digital assistance can be used as the terminal device 2, highly confidential information may possibly be accessed even by an unauthorized user in a case that the insurance company provides information from the management device 2 to the terminal device 3. That is, there are cases where the sales representative of the insurance agent loses his/her portable terminal device, the terminal device is shared by the sales representative of the insurance agent and an ineligible insurance producer, and a computer of an Internet cafe or a customer is carelessly forgotten to be switched off after use, consequently to leave insurance contract data or insurance-related data, as typical examples. The information for insurance contract contains important data such as the personal information of the customer or insurant must be held in strict confidence so as not to be misused. Accordingly, the system of the invention can improve the security of personal information by recognizing the status of the connection between the management device 2 and the terminal device 3 and transmitting to the terminal device 3 the necessary information on the basis of the connection status.

The connection information acquisition means 211 in the embodiment (1) of the invention includes a terminal authentication information acquisition means 2111 for obtaining the terminal authentication information, and an agent authentication support means 2112 for transmitting an agent authentication information entry form for urging the agent to enter the agent authentication information previously appointed by the insurance company, an agent authentication information acquisition means 2113 for obtaining agent authentication information filled in the agent authentication information entry form, and a location authentication information acquisition means 2114 for obtaining the location authentication information.

The terminal authentication information obtained by the terminal authentication information acquisition means 2111 indicates which terminal device 3 is accessed to the management device 2 and is automatically transmitted to the management device 2 when the terminal device 3 is connected to the management device 2. Even if the management device does not acquire the terminal authentication information from the terminal device 2, the terminal device 3 may be accessed to the management device 2, but the authentication level as described later is influenced. The prescribed terminal device 3 implies a terminal station placed at an insurance agent office or shop, a user terminal set possessed by a sales representative (insurance salesperson) of the insurance agent, or the like.

In a case of using a desktop computer or portable computer such as personal digital assistance (PDA) as the terminal device 3, the terminal authentication information is installed in advance on the terminal device 3, so as to automatically submit the terminal authentication information from the terminal device 3 to the management device at the time of connecting the terminal device to the management device (referred to as “client authentication”), temporarily generate one-time password that changes with every use in accordance with system time or counter value in the terminal device or management device to enhance the security (one-time password authentication), or collate user's autographic information such as a signature with individual data previously stored on the management device (signature authentication, or sometimes referred to as biometric authentication). The one-time password authentication enables coinstantaneous terminal and agent authentication. In a case of using a cell phone as the terminal device 3, the authentication can be conducted by plugging a dedicated adapter into the user's cell phone or giving a one-time password to the user. By inserting the dedicated adapter into the cell phone, automatic connection of the cell phone to the management device 2 can be fulfilled, simultaneously submitting the authentication data stored on the dedicated adapter to the management device. In this case, when the sales representative of the insurance agent brings his/her cell phone with its dedicated adapter, his/her authentication information can be automatically submitted to the management device by inserting the adapter into the cell phone. The adapter should be possessed by a person authorized by the insurance company, and as a general rule, it is required to provide one adapter for every one insurance agency, but when the insurance agency has a plurality of salespersons (employees), the insurance company may supply as many adapters as the number of employees. The terminal authentication information containing information of the insurance agency (agent's name, kind of agency, contact information, etc.) is stored on the database in correlation with authentication manner (for client authentication, one-time password authentication or signature authentication and model type of adapter).

The agent authentication support means 2112 transmits an instruction form to ask for entering the agent authentication information to the terminal device 3 being accessed to the management device 2 through the compensating section 23. The agent authentication information is personal data such as ID code and password, which is indicative of who is connected to the management device 2. As a general rule, one piece of agent authentication information is provided for every one insurance agency, but when the insurance agency has a plurality of salespersons (employees), the insurance company may give the insurance agency a plurality of authentication information. Realistically speaking, there are many associated concerns (channels) acting as insurance agencies such as a specialized insurance agency, car maintenance shop, second-hand car dealership, new-car sales dealership, and auto distributor, so the agent authentication information may contains data capable of discriminating the associated concerns. The agent authentication information is previously stored on the agent authentication information database 214 in correlation with the agency information (agent's name, kind of agency, contact information, etc.) assigned to the insurance agent in advance. The meaning of the insurance agent implies insurance salespersons (insurance solicitors) employed for person-to-person selling by the insurance agency.

The location authentication information acquired by the location authentication information acquisition means 2114 is indicative of where the terminal device 3 is accessed to the management device 2. The location authentication information may be created from an IP address or other specific data, but is not initially allocated as a verification code by the insurance company. Thus, the location authentication information is produced by identifying whether the specific terminal device 3 is accessed to the management device 2 through a registered network from the IP address or other specific data. The information indicative of the usage of the network and IP address is stored on the location authentication information database 215 in correlation with the agency information (agents name, kind of agency, contact information, etc.) That is, when acquiring the location authentication information stored on the location authentication information database 215, it is deemed that the terminal device 3 is accessed from a high-security place to the management device 2. As the high-security place, there are enumerated premises of an insurance sales agency and insurance company, and network environment offered by the insurance company. On the contrary, an Internet cafe, business satellite office in a hotel, customer's home, and home of the insurance salesperson of the insurance agency may be said as low-security places. When using the portable computer, personal digital assistant (PDA) and cell phone as the terminal device 3, the authentication cannot be executed with reference to the location authentication information, but fulfilled referring to the agent authentication information and terminal authentication information.

The authentication means 212 includes a collation means 2121 for collating the connection information, and a level determination means 2122 for determining an authentication level according to whether the connection information can be obtained or not and/or the terminal device can be identified or not. When the terminal authentication information, agent authentication information and location authentication information are obtained, the collation means 2121 performs confirmation whether these information data coincide with the corresponding data stored previously on the terminal authentication information database 213, agent authentication information database 214 and location authentication information database 215.

The level determination means 2122 performs determination of the authentication level according to what combination of the connection information data (terminal authentication information, agent authentication information and location authentication information) recognized by the collation means 2121 is authenticated. The level determination is shown in Table 1 below by way of example.

TABLE 1

| | Availability of information | | | | | | | |
|---|---|---|---|---|---|---|---|---|
| Terminal | ◯ | | | | X | | | |
| Authentication | | | | | | | | |
| Information | | | | | | | | |
| Agent | ◯ | | X | | ◯ | | X | |
| Authentication | | | | | | | | |
| Information | | | | | | | | |
| Location | ◯ | X | ◯ | X | ◯ | X | ◯ | X |
| Authentication | | | | | | | | |
| Information | | | | | | | | |
| Authentication | 1 | 1 or 2 | 2 | 2 | 3 | 3 | 4 | 4 |
| Level | | | | | | | | |

In the Table 1, the case where all the acquired terminal authentication information, agent authentication information and location authentication information coincide with the authentication data stored on the database is expressed as ◯, and the case where all the acquired authentication information do not coincide with the same is expressed as x. The authentication level is classified into four levels, Level 1 to Level 4, according to the combination of terminal authentication information, agent authentication information and location authentication information. As seen from Table 1, the case in which all the terminal authentication information, agent authentication information and location authentication information are determined as ◯ falls into the highest level, Level 1. The case in which the agent authentication information is determined as ◯ and one or both of the terminal authentication information and location authentication information are determined as X falls into Level 2. In this case, there is an exception that the case where an unverified portable personal digital assistance (PDA) or cell phone is used as the terminal device 3, but the agent authentication information and terminal authentication information are authenticated falls into Level 1. The case where the agent authentication information and terminal authentication information are determined as x falls into the lowest level, Level 4. The other cases than those mentioned above fall into Level 3.

The classification of the levels shown in Table 1 is shown by way of example only, and it should not be limited thereto. The location authentication information is classified into two in this example, but it may be further classified into subclasses. The agent authentication information is also subclassified in accordance with the nature (channel) of the insurance agency. The connection information in this embodiment comprehends the terminal authentication information, agent authentication information and location authentication information, but it should not be limited to these component factors. For example, in this system, the location authentication information may be omitted, and instead, the authentication may be prosecuted by combining the terminal authentication information and agent authentication information, or using only the agent authentication information, or adding any other authentication information to the agent authentication information.

Next, the application section 25 will be explained. The application section 25 includes a service information means 251 for notifying available services offered from the management device 2 by the insurance company to the terminal device 3, an application assist means 252 for issuing insurance-related information for issuing insurance-related information for making the management device available to the terminal device of any type in accordance with terminal discriminating information and assisting the routine clerical work of making an insurance policy application form with reference with the information sent from the terminal device 3, an insurance-related information database 253 storing insurance contract business information as the insurance-related information, and application form drawing means 254 for making an insurance application form on the basis of the information sent from the terminal device 3. The insurance-related information database 253 is composed of a plurality of database units and may be disposed outside the management device 2.

The service information means 251 serves to transmit information of services, which the management device 2 can offer to the terminal device 3, so as to display the information on the display of the terminal device 3 in the form of a menu 2511. On the menu 2511, the available services offered from the insurance company to the insurance agent are itemized with adequate item names, respectively. For instance, the services offered by the insurance company include an insurance contract service for forging an insurance contract, a sales assistance service for assisting the insurance sales, an information inquiry service for asking for various insurance-related information, an accident-related information service, and other services. Further, the insurance contract service is mainly for renewable car insurance contract, new car insurance contract, insurance contract accounting, and acceptance of change. The sales assistance service is mainly for premium estimation, and premium settlement (including credit-card authorization). The information inquiry service is mainly for inquiring for available insurance contract, insurance policy, record of concluded insurance contract and pending insurance contract, contents of insurance policy, rules and regulations of insurance policy, insurance covenant, and other information. The accident-related information service is mainly for progress report of disposition of car accident, acceptance of disposition of car accident, and handling of insurance claims. The aforementioned services are just examples among many and should be limited thereto. These services are notified to the terminal device 2 in the form of the menu 2511. The menu 2511 may be formed in a hierarchical tree-structure on the display of the terminal device.

Determination which ones of the services offered by the insurance company are available to the customer or the insurance agent depends on the authentication level decided by the authentication section 212 in accordance with the terminal device 3 accessible to the management device. The routine clerical work performed by the management device 2 for assisting the operation of the terminal device 3 is indicated as distinction of services available to the terminal device 3. The application assist means 252 assists the operation of browsing the insurance-related information on the display of the terminal device upon acquirement of at least the agent authentication information from the terminal device, and the operation of handling the insurance contract upon acquirement of at least the agent authentication information and terminal authentication information. The services offered by the insurance company and the authentication levels necessary for enjoying the available services are shown in Table 2 below by way of example.

TABLE 2

| | | Required |
|---|---|---|
| | | Authentication |
| Services | | Level |
| Insurance Contract | Renewable car insurance contract | 1 |
| | New car insurance contract | 1 |
| | Acceptance of change | 1 |
| | Insurance contract accounting | 1 |
| Insurance Sales | Premium trial-calculation | 2 or more |
| | Premium payment and settlement | 1 |
| Information Inquiry | Insurance information inquiry | 1 |
| | Record of concluded and pending | 1 |
| | insurance contracts | |
| | Contents of insurance policy, and | 2 or more |
| | rules and regulations of insurance | |
| | policy | |
| | Announcement of insurance | 2 or more |
| | company | |
| | Phone directory | 2 or more |
| Accident-related | Progress report of disposition of | 1 |
| Information | car accident | |
| | Acceptance of disposition of car | 1 |
| | accident | |
| | Handling of insurance claims | 1 |

In the case of the authentication Level 1 based on Table 1, which indicates that the authenticated user (insurance agent) uses the authenticated terminal device 3 at a high-security level place, all the services are available to the user. In the case of the authentication Level 3 or Level 4 based on Table 1, which indicates that the terminal device is not used by an authenticated user (insurance agent) and thus the management device cannot acquire the agent authentication information, none of services can be offered. In the case of the authentication Level 2 based on Table 1, which indicates that the authenticated user (insurance agent) uses an unauthenticated terminal device, the service information offered by the insurance company to the terminal device is in the treat of being used fraudulently. In this case, only the information inquiry service other than the insurance-related services and the sales assistance service for assisting the insurance sales is available to the user. That is, the highly confidential information concerned with insurance contract operation or individual insurance policy (inquiries of insurance policy and accident-related information) is not available.

Incidentally, the authentication level in Table 2 is set at Level 3 or Level 4, but services (brief information of insurance goods or advertising contents) available correspondingly to the authentication levels may be provided. To prescribe the agent authentication information so as to identify the status of a person responsible of the insurance agent (individual authority) and kind (channel) of the insurance agent, the information to be disclosed may be restricted in accordance with the nature of the agency identification data acquired by the management device when take advantage of various information services inquired by the user. That is, in a case where the agency identification data are categorized in accordance with, for example, the salesperson individual and sales representative of the insurance agency, and representative for selling insurance of a car dealer, the scope of customers' data to be disclosed at the request of the insurance agency may be expanded to subjective data of salesperson individual and concerned insurance sales branch and ultimately up to the company-wide data of the insurance company. On the menu showing the services offered to the terminal device 2 by the insurance company, all the services may be displayed in a selectable manner to choose further menu options according to the authentication level, or only the services available to the user or customer according to the authenticated level may be displayed.

The application assist means 252 serves to transmit to the terminal device 3 an instruction form to ask for entering the necessary insurance-related information in accordance with the service selected on the terminal device 3 in order for assisting various routine clerical works for proceeding with the insurance contract as indicated on the menu 2511. The information displayed on the terminal device 3 in connection with the available services may include insurance-related information, which is allowed merely to be browsed, and fill-in forms to be filled out following the instructions displayed on the terminal device. Ordinarily, one of new contract procedure and renewal contract procedure must be alternatively chosen in performing insurance contract services, which are different in arranging procedure, and a common procedure in estimating premium and effecting insurance contract, consequently to temporarily suspend a clerical work for arranging insurance contract. To cope with such a clerical work, the application assist means 252 is provided with a plurality of matching means capable of preparing a plurality of required forms to be transmitted to the terminal device 3 so as to fitly choose combination and/or operating order of the matching means in accordance with interaction between themselves and the terminal device 3.

The means associated with the new insurance contract service, which is incorporated in the application assist means 252, include a vehicle information assist means for producing a vehicle information entry form to assist entering of vehicle information data (vehicle type, car registry number, vehicle name, type number, initial registration date, etc.), an insurant information assist means for producing an insurant information entry form to assist entering of insurant information data (name, phonetic name, postal zip code, domicile, phone number, e-mail address, etc.), a recommended insurance advice means for transmitting information of insurance contract recommended to the customer or insurant selected according to the vehicle information, and a trial-calculation representation means for representing a trial-calculation result 23241 of insurance premium estimated according to the contract desired by the customer or insurant. The means associated with the renewal insurance contract include an expiration information transmission means for notifying contract expiration information of the contracted insurance (expiration list or the like) of the insurant (customer already insured) to which the sales representative of the insurance agent already accessed to the management device 2 provides support, an expiration notice transmission means for transmitting notice of insurance expiration information, which was already mailed to the insurant prior to the expiration date of an insurance policy, and an insurant information transmission means for displaying insurant information (name, phonetic name, postal zip code, domicile, phone number, e-mail address, etc.) The application assist means further comprises other means for providing variety of other service information.

The insurance related information database 253 further comprises means for assisting the operation of the application assist means 252, which include an insurance policy database 2531 storing an insurance policy in correlation with the vehicle information, a premium trial-calculation database 2532 for tentatively calculating the insurance premium in accordance with the insurance contract, an expiration information database 2533 storing expiration information such as the insurance agent having charge of the insurant whose insurance policy is expiring, expiration date, recommended insurance plan and other information, and an insurant database 2534 storing the insurance information of the insurant (name, phonetic name, postal zip code, domicile, phone number, e-mail address, etc.)

The application form drafting means 254 is provided for making up an application form 2541 upon receiving the vehicle information inputted on and submitted from the terminal device 3 by using the application assist means 252, and the application data including the insurant information and the insurance policy selectively or optionally concluded, and other information data.

The application assist means 252 and the insurance related information database 253 should not be limited to the foregoing and may be modified or compensated in number according to the procedures of preparing the application form and the services prescribed by the management device 2. As the need arises, image data of a driver's license and/or a vehicle inspection certificate or electronic data of license information stored in an IC memory may be submitted from the terminal device 3 to the management device 2.

The variety of information entry forms to be transmitted from the application assist means 252 to the terminal device 3 may be provided in the form of a frequently used menu automatically customized on the basis of a history of usage, or in an easy manner of possibly saving the character inputting operation so as to select the necessary items from a hierarchical menu while omitting unwanted input items, under the assumption of using a cell phone as the terminal device 3 by way of example. Thus, the system of the invention can take into account utilization of the services offered by the insurance company using the cell phone having many restrictions.

Next, the contract section 27 will be explained. The contract section 25 is provided with an application form transmission means 271 for transmitting the application form 2541 drawn up on the basis of the application information to the terminal device 3, a contract conclusion means 272 for completing the insurance contract upon receiving confirming information indicative of confirmation of the application form from the terminal device 3, a payment means 273 for arranging for insurance payment, and a contract completion notification means 274 for notifying completion of the insurance contract to the terminal device 3.

The application form transmission means 271 serves to transmit the application form 2541 drawn up by the application form drafting means 254 to the terminal device 3 to display the form on the terminal device. The complete data required for the insurance contract, which are the same as those filled in a conventional application form are displayed on the display screen of the terminal device.

The contract conclusion means 272 is provided with a confirmation assist means 2721 for transmitting to the terminal device 3 a confirming information entry form 2721 for assisting the filling-in of the confirming information data, and a confirming information detection means 2722 for detecting whether or not the confirming information is submitted from the terminal device 3. The confirming information is dedicated for determining that the contents of the application form 2541 is confirmed by the insurant by use of the management device 2, correspondingly to a written contract under seal. Since the sales representative should give an explanation of the important details (insurance coverage, nonresponsibility clause, insurance policy terms for insurants age, and duty of notification of change of insurance policy and possible accidents) of the insurance policy in confirming the application data, the confirming information semantically implies that the insurant has been made aware of the insurance policy. The important details explained to the insurant contains obligation of representation and notification, insurance coverage, roles of the insurance agent, general contractual conditions and so forth. The confirming information should preferably be an insurant's own or specific information such as date of the insurant's birth, which the sales representative of the insurance agent does not know, in order to prevent impropriety. It is desirable for the insurant to block views of others including the sales representative of the insurance agent when entering the confirming information. There are other confirming methods using the number of the health insurance card or public number of the insurant, if any, or individual identification means, which will possibly be established by the government in future.

The payment means 273 is provided for carrying out the procedure for insurance payment upon submitting a form for applying payment of insurance benefit and filling in the necessary information on the terminal device 3. The payment means 273 allows the insurant to select a method of insurance payment (cash payment, credit card, direct debit and net debit transactions, convenience banking payment, cellphone's payment, etc.), and assists the filling-in of the data necessary for payment of the insurance benefit. The insurance payment information contains the credit card number, expiration date of the credit card and other personal information in the case of the credit card or net debit transactions, the account number, account holder's name and other personal information in the case of the account transfer payment, and information such as the name of the appointed convenience banking and e-mail address to which a store reception number is sent in the convenience banking payment. For the cellphone's payment, credit card data saved in an IC chip in the cellphone of the customer are used. In the case of using the credit card settlement, authorization (acceptance of credit card transactions) can be conducted via communication line.

The contract completion notification means 274 serves to transmit to the terminal device 3 a contract completion notice upon completion of the payment procedure in the payment means 273 after detecting the confirming information by the confirming information detection means 2722 and then display the contract completion notice on the terminal device. Thus, the sales representative of the insurance agent and the customer or insurant can recognize the conclusion of the insurance contract. The customer or insurant comes in very useful when receiving notification of the conclusion of insurance contract, which is sent to customers mail address (E-mail address of a cell phone, personal computer or the like of the customer or insurant). In a case of making arrangements for insurance contract by using an unauthorized terminal device, the notification of the conclusion of insurance contract should be sent to the ascertained terminal device of the insurance agency by E-mail, consequently to allow the insurance agency to appropriately confirm the conclusion of insurance contract.

Next, the accounting section 29 will be described. The accounting section 29 is provided with an accounting assist means 291 for transmitting to the terminal device 3 an accounting instruction form 2911 for giving accounting instructions to record accounting of the concluded insurance contract, an insurance accounting means 292 for accounting the concluded insurance contract to the insurance company in accordance with the accounting instruction information received from the terminal device 3, a completed accounting notification means 293 for transmitting to the terminal device 3 a completed accounting notice 2931 of the completed accounting of the insurance contract, and confirmation drawing means 294 for making up a concluded contract confirmation to be given to the customer.

The accounting instruction information is entered into the terminal device 3 referring to the accounting instruction form 2911 given from the accounting assist means 291. The accounting instruction information is provided for reporting the contents of the concluded insurance contract to the insurance company and conclusively confirming the agents decision accounting for the concluded insurance contract. Only by selecting the item “booking” 2912 on the display of the terminal device 3, the agents decision can be submitted.

The contents of the concluded insurance policy fulfilled in the contract section 27 is recorded by using the insurance accounting means 292 in accordance with the accounting instructions sent from the terminal device 3. The booking of the concluded insurance contract is registered in database on the insurance policy in the host computer of the insurance company. This online data processing method is alternative to a conventional procedure using a system for sending the necessary documents by postal mail or facsimile and reading the data on the documents using an OCR device. The insurance accounting means 292 serves to enter into the host computer 5 the contents on the application form 2541 drawn up in the interactional sequences described above using the management device 2 without modification. Although the concluded insurance policy is booked with direction by the terminal device 3 in this embodiment (1), it may be booked without direction by the terminal device 3 at the time of concluding the insurance contract.

The completed accounting notification is displayed on the display of the terminal device 3 by the completed accounting notification means 293 to make the booking of the concluded insurance contract known to the sales representative of the insurance agent.

With the confirmation drawing means 294, a written contract confirmation to be sent to the insured customer or insurant by postal mail is made up. The contract documents are sent from the insurance company directly to the insurant by postal mail along with the insurance policy, so that even unauthorized or fraudulent contract can be learnt and signed off from the reaction or feedback from the customer. Although the written contract confirmation is sent to the customer in this embodiment by postal mail, it may be sent to the customer's e-mail address by e-mail.

As will be appreciated from the foregoing, the terminal device 3 is an optional element basically having functions of receiving the information from the management device 2, displaying the information to permit the user to enter required data referring to various instruction forms, and submitting the entered information to the management device 2.

In a case of using a cell phone as the terminal device 3, a dedicated adapter connection means 31 may be used with an detachable dedicated adapter, which is inserted into the terminal device, so that the terminal device intended to access to the management device 2, if specified or unspecified, as to automatically connect the terminal device 3 to the management device. There are previously stored the terminal authentication information and URL information of the management device 2 in the dedicated adapter, so that the terminal device 3 can be automatically accessed to the management device 2 only by inserting the detachable dedicated adapter into the terminal device 3. The cell phone to which the dedicated adapter possessed by the sales representative of the insurance agent is attached can be identified as the authenticated terminal device 3 by the management device 2 of the insurance company when plugging the dedicated adapter into the cell phone in conducting the insurance contract. When putting this system to practical use with the dedicated adapter, the cell phone owned by the customer or insurant may be used, but it is desirable to use the cell phone possessed by the salesperson or sales representative of the insurance agent because of the security reasons.

Irrespective of the structure in the aforementioned embodiment (1), there may be omitted the information compensation means 231 of the compensating section 23 and terminal discriminating database 232, so as to previously hold the information to be primitively transmitted from the management device 2 to the terminal device 3 according to the type of the terminal device 3, so that the information corresponding to the respective terminal device 3 accessible to the management device in accordance with prescribed terminal discriminating information. For instance, the application section 25 may be provided with a plurality of insurance-related information for various types of the terminal devices 3 accessible to the management device.

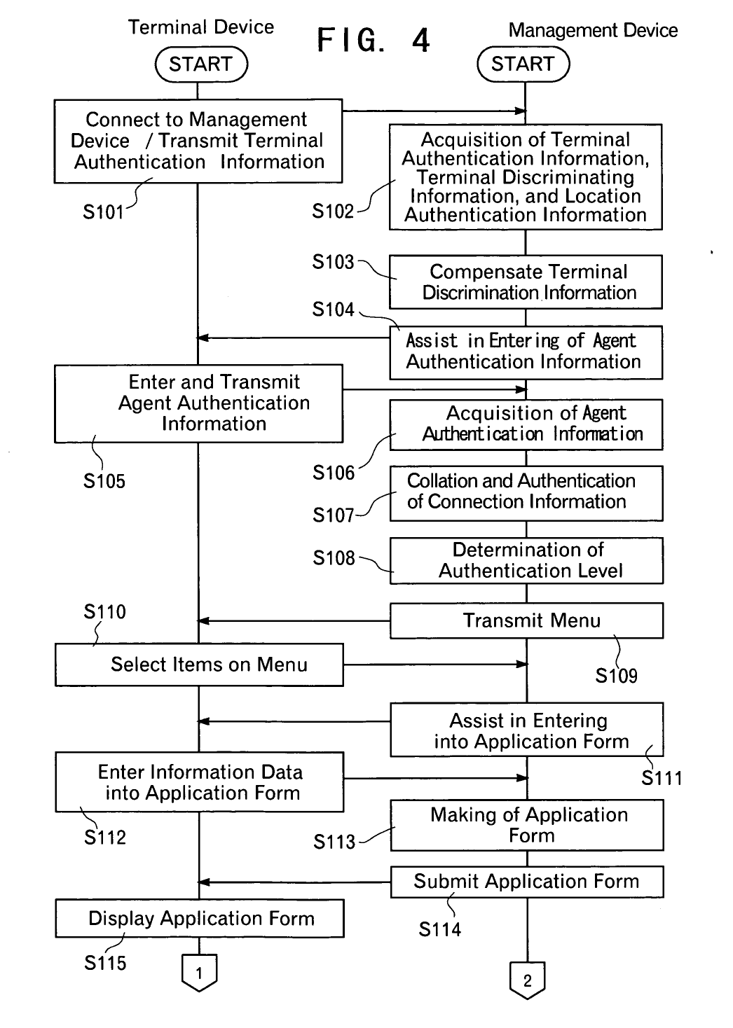

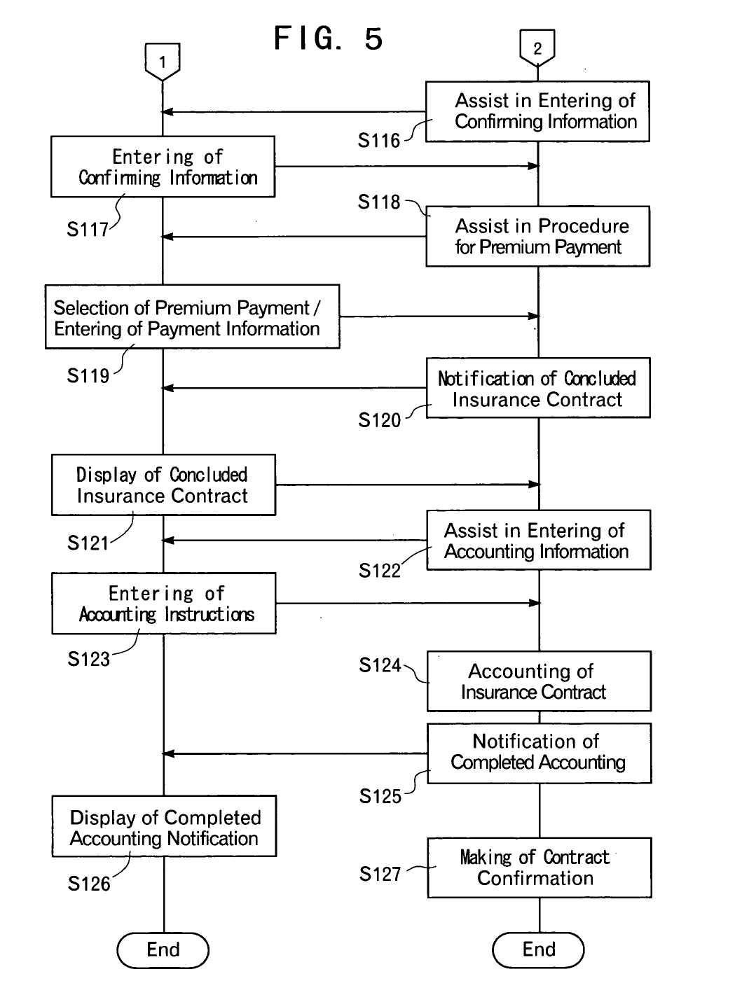

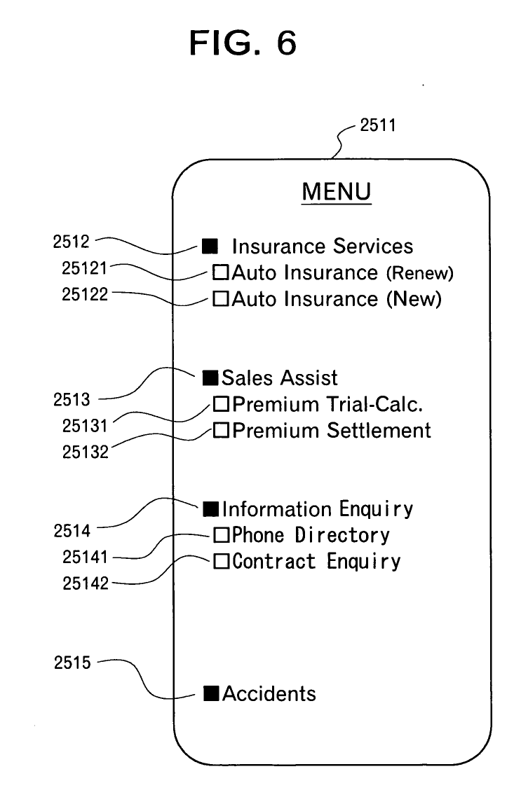

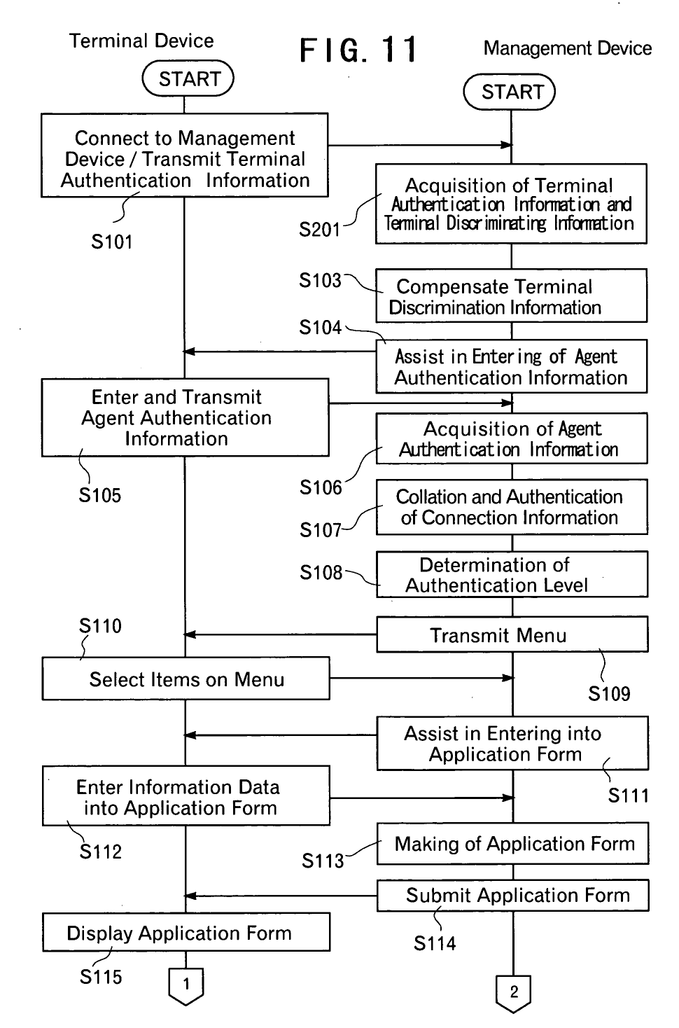

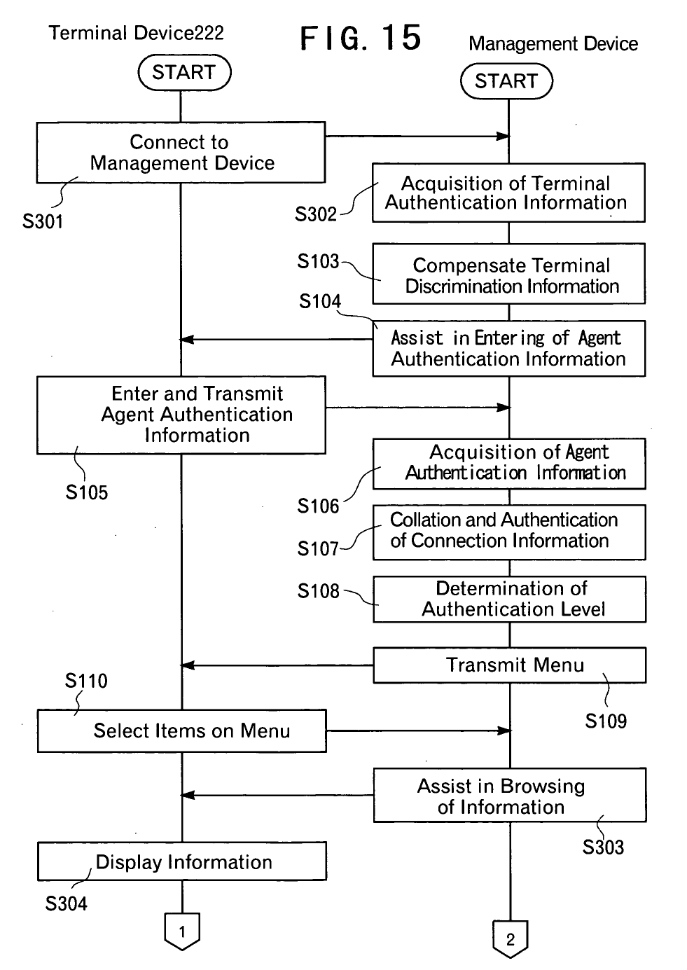

The insurance contract support system 1 in the embodiment (1) will be clarified hereinafter with reference to FIGS. 4 through 15. FIGS. 4 and 5 are flow charts showing the operating of the first working example 1. FIG. 11 is a flow chart showing the operating of the second working example 2. FIG. 11 continues onto FIG. 5. FIG. 15 is a flow chart showing the operating of the second working example 3. FIGS. 6 to 10 and FIGS. 12 to 14 are the screen-displayed examples on the display of the terminal device.

### WORKING EXAMPLE 1

There will be described herein the first working example 1 in which the system in this working example 1 is applied for placing new insurance contract while the management device 2 receives both the terminal authentication information and the agent authentication information. This example may be applied to the other procedures than that for new insurance contract.

First, the sales representative of the insurance agent handles a specified or unspecified terminal device 3 to be connected to the management device 2 via the network 4 in conducting the insurance contract. Since the new insurance contract requires the highest authentication level “Level 1”, the sales representative of the insurance agent accesses a Web site administered by the management device 2 via the Internet by using the terminal device installed in the insurance agency office or shop.

Since the personal computer set up as the terminal device 3 in the insurance agency office or business shop is connected to the management device 2, the terminal authentication information for client authentication is transmitted to the terminal authentication information acquisition means 2111 of the management device 2 at the time of connection (S101). The terminal discriminating information, which indicates that the terminal device 3 being accessed to the management device is the personal computer, is transmitted to the terminal discriminating information acquisition means 233, as the case may depend on the kind and version of a browser installed on the computer, and at the same time, the location authentication information identified with an IP address is transmitted to the location authentication information acquisition means 233 (S102). The terminal discriminating information transmitted to the management device 2 is collated with data stored on the terminal discriminating database 232 to determine how the information is compensated by the information compensation means 231 when transmitted to the terminal device 2 (S103). The information to be transmitted from the management device 2 to the terminal device 2 after this time is always compensated with the information compensation means 231. This compensation of the information to be transmitted to the terminal device 3 is necessarily made according to the personal computer serving as the terminal device.

Subsequently, the agent authentication information entry form is transmitted from the agent authentication support means 2112 of the management device 2 to the corresponding terminal device 3 (S104). On the terminal device 3 which receives the agent authentication information entry form, an instruction image for letting the sales representative enter a given ID code and password. The sales representative of the insurance agent or insurance solicitor enters the ID code and password previously given to the insurance agent into the terminal device, so that the ID code and password entered by the sales representative are submitted to the management device 2 (S105) and inputted into the agent authentication information acquisition means 2113 (S106). Regardless of whether the terminal authentication information is submitted, the agent authentication information entry form is transmitted from the agent authentication support means 2112 to the relevant terminal device 3. However, since the contract service is performed at the highest authentication level, it is required to make the terminal device 3 responsive to the prescribed authentication level so as to get the sales representative to submit not only the prescribed terminal authentication information but also the agent authentication information to the management device. Since the personal computer is used as the terminal device 3 in this embodiment, the terminal device 3 should be used in such surroundings that the location authentication information with a high-security level can be transmitted to the management device. Subsequently, to authenticate the user of the terminal device 3 with the authentication means 212, the terminal authentication information and the agent authentication information are verified with the terminal authentication information database 213 and agent authentication information database 214 by using the collation means 2121 (S107). Then, the authentication level of the terminal device 3 attempting to be connected to the management device is determined in accordance with a combination of the terminal authentication information and agent authentication information (S108). The authentication level in this situation is the highest Level 1 since both the terminal authentication information and agent authentication information are received.

Next, the services contributing to the terminal device 3 is notified in the form of a menu to the terminal device through the service information means 251 in accordance with the result of determination of the authentication level obtained by the level determination means 2122 (S109). Since the authentication level in this case is determined as the highest level, all the available services are displayed on the display of the terminal device 3, so that the customer can select whichever service the customer wants. The example of the representation of the displayed menu 2511 is shown in FIG. 6. The menu 2511 contains the major items “Contract Services” 2512, “Sales Assist” 2513, “Enquiry” 2514, and “Accident” 2515, and the minor items “Auto Insurance (renewal)” 25121, “Auto Insurance (new)” 25122, “Trial Calculation” 25131, “Settlement” 25132, “Phone Directory” 25141, and “Contract Enquiry” 25142. Some of services shown in Table 2 are displayed as the available services. As an example, the item “Auto Insurance (new)” 25122 is selected to pursue new insurance contract and notified to the management device 2 (S110).

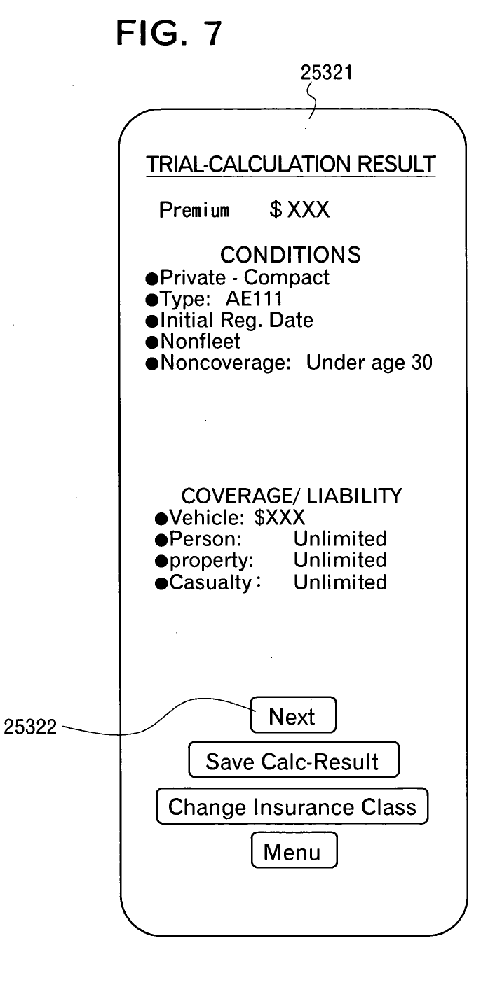

The application data entry form for one selected from various insurance services is given to the terminal device 3 by using the application assist means 252 in the management device 2 in order to make up an application form for new insurance contract of the auto insurance (S111). The application data entry form sent from the management device is displayed on the display of the terminal device 3, so as to allow the sales representative of the insurance agent or the customer to enter the necessary information data into the application data entry form displayed on the screen. The application data entered into the terminal device are submitted to the management device 2 in sequence (S112), and then, a new contract application form 2341 is drawn up (S113). These processes (S112)-(S113) may be repeated as circumstances demand. The forms transmitted from the management device 2 include a vehicle information entry form for vehicle data such as the vehicle type, car registry number, vehicle name, type number, and initial registration date of the subject vehicle, and an insurant information entry form for insurant data such as the name, phonetic name, postal zip code, domicile, phone number, and e-mail address of the subject insurant. Further information such as recommended insurance advice and trial-calculation result may be transmitted to the terminal device according to the data or selection entered into the terminal device 3. Information exchange between the management device 2 and terminal device 3 is made while referring to the data stored on the insurance-related information database 253. When the customer asks for the estimate of premium but does not apply for insurance contract on this occasion, formulation of the application form for insurance contract is discontinued, and then, the data entered into the application form as shown in FIG. 7 displayed are stored for calculation of estimated premium. The trial-calculation result may be printed out or transmitted to the terminal device of the customer or insurant.

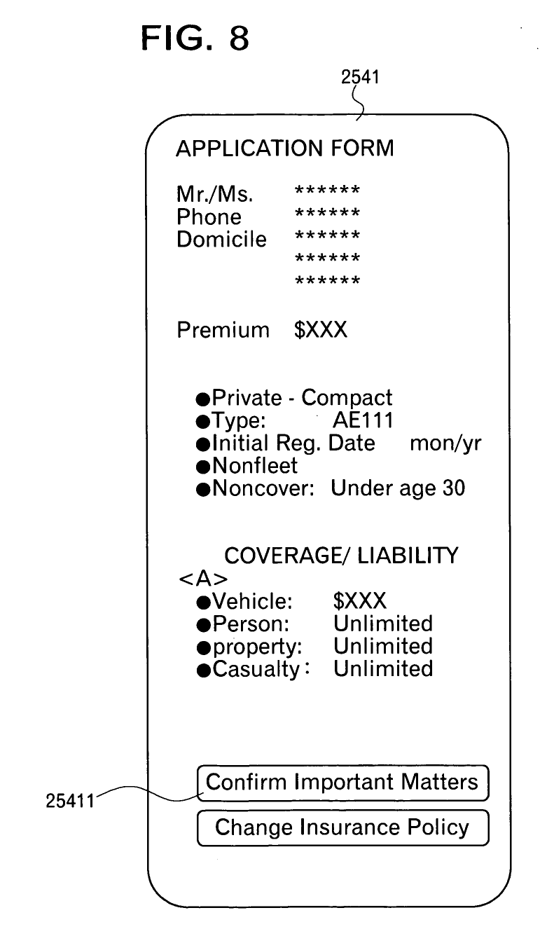

Upon completion of the application form 2541 with the application assist means 252 as shown in FIG. 8, the completed form is transmitted from an application form transmission means 271 to the terminal device 3 and displayed there (S114 and S115). The details of the contract policy prepared are confirmed while the sales representative give the explanation of the contract policy to the customer, showing the application form on the display of the terminal device. Upon completing confirmation of the details of the contract policy, “Confirm Important Matters” 25411 is selected to be transmitted to the management device 2. In response thereto, a confirming information entry form 27211 is transmitted from the confirmation assist means 2721 of the contract conclusion means 272 in the management device 2 to the terminal device 3 (S116).

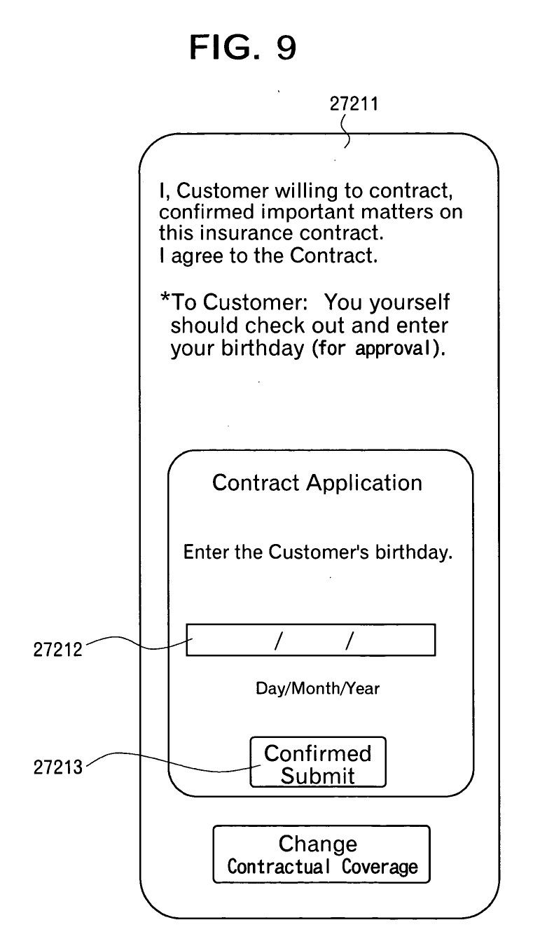

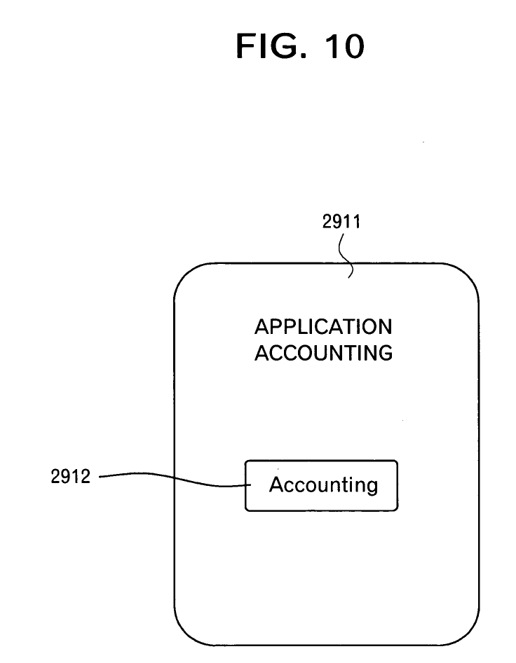

Then, the confirming information entry form 27211 is displayed on the display of the terminal device 3 as shown in FIG. 9, so as to let the customer enter the customer's personal information such as the customer's birthday 27212. Entering of the customer's birthday 27212 implies acceptance of the insurance contract by the customer after being informed of the details of the insurance contract. Then, “Conform/Submit” is selected to be transmitted to the management device 2 (S117). Consecutively, the payment means 273 in the management device 2 is worked to assist the procedure of payment (S118). In the procedure of payment, upon reception of a payment selection form sent from the management device 2, the customer selects any of “Cash Payment”, “Credit Card Payment”, or other payment method, the customer prefers. Upon entering the necessary item on the payment selection form, the input data are transmitted to the management device 2 (S119). These processes (S118)-(S119) may be repeated as circumstances demand. Through these procedures, the insurance contract is concluded, consequently to transmit a contract completion notification from the contract completion notification means 274 in the management device 2 to the terminal device (S120), and display the notification sent from the management device on the screen of the terminal device 3 (S121). The contract completion notification is visible to the customer on the screen of the terminal device, so that the customer can be made aware of conclusion of the insurance contract. Then, an accounting instruction form is transmitted from the accounting instruction form 291 of the management device 2 to the terminal device (S122), and displayed on the display of the terminal device as shown in FIG. 10, and thereupon, by selecting “Accounting” 2912 on the terminal device, it is notified to the management device 2 (S123), the contents of the application form 2541 are accounted for by the host computer 5 of the insurance company through the insurance accounting means 292 (S124).

This electronic accounting system prevents erroneous procedures such as reading mistake, which often occurred heretofore and eliminates the need for preparing OCR data of the insurance contract information. Besides, no specific operation is needed for transmitting the information data, and preparation of the application form can easily be performed only by giving an accounting command at the end of the procedures for preparing the application form without imposing any burden on the insurance agent and the insurance company (including the branch offices thereof). Upon completion of the accounting procedure involving in proceeding with the insurance contract, a completed accounting notification is transmitted from the completed accounting notification means 293 to the terminal device 3 (S125-S126). Seeing the notification on the display, the sales representative of the insurance agent can make sure completion of the accounting. Upon accounting the insurance contract, a written contract confirmation to be submitted to the customer or insurant is made up with the confirmation drawing means 294 of the management device 2 (S127). The written contract confirmation is formally printed out and forwarded to the customer by postal mail after 3 business days of conclusion of the insurance contract. The forwarding by mail of the written contract confirmation to the customer prevents a fraudulent contract placed without customer's knowledge or other irregularities in a contract, thus to ensure appropriate procedures for making an insurance contract. After concluding the insurance contract the customer desires, there may be employed a follow-up service system for allowing the customer or insurant to confirm the conditions of the insurance contract by telephone or through a network as quick as a call center of the insurance company receives inquiry from the customer or insurant. This follow-up system can dispel anxieties about insurance operation.

### Working Example 2

The working example 2 for carrying forward the procedures for a continuing insurance contract with the management device 2 getting both the terminal authentication information and the agent authentication information will be described here. The same operation as in the new insurance contract described above will be omitted.

Conventionally, an application form for continuing insurance contract was heretofore forwarded by postal mail to the customer or insurant having the insurance policy close to the expiration, thus causing the drop of the percentage of contract conclusion. Consequently, an insurance solicitor of the insurance company or insurance agent often canvasses for renewal insurance. Thus, even accidental encounter of the insurance agent with the customer having the insurance contract expiring soon marks a great opportunity for getting the insurance contract. If the insurance solicitor or agent does not carry an exclusive portable terminal device, which has been so far used, and/or sales papers such as insurance guide brochures at a time like this, the insurance solicitor or agent can offer various insurance services by using his/her own terminal device 3. For example, in proceeding with sales dealings for insurance contract at a coffee shop with the customer, the insurance solicitor or agent can automatically accessed to the Web site managed by the insurance company merely by plugging a dedicated adapter to his/her cell phone via Internet.

Thus, the terminal authentication information is automatically transmitted to the management device 2 by plugging the dedicated adapter into the terminal device 3 to connect the terminal device to the management device 2 with the dedicated adapter connection means 31 (S101). Simultaneously, the terminal discriminating information acquisition means 233 acquires the terminal authentication information indicating that the terminal device connected to the management device is the cell phone, referring to the information data sent from a cell-phone operator (carrier). However, since the cell phone is used in this case, the location authentication information cannot be acquired (S201). Thus, the management device 2 determines how the terminal discriminating information is compensated through the information compensation means 231, referring to terminal discriminating database 232, when transmitting the information to the terminal device 3 (S103). The subsequent processing is carried out while compensating the information data to be transmitted from the management device 2 to the terminal device 3 in accordance with the displaying ability of the terminal device 3. The compensation appropriate for the cell phone serving as the terminal device is always performed every time the information data are transmitted to the terminal device.

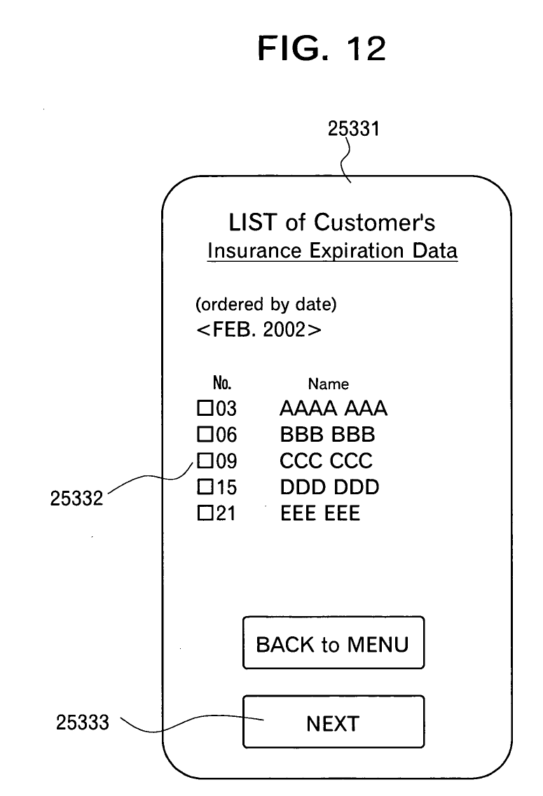

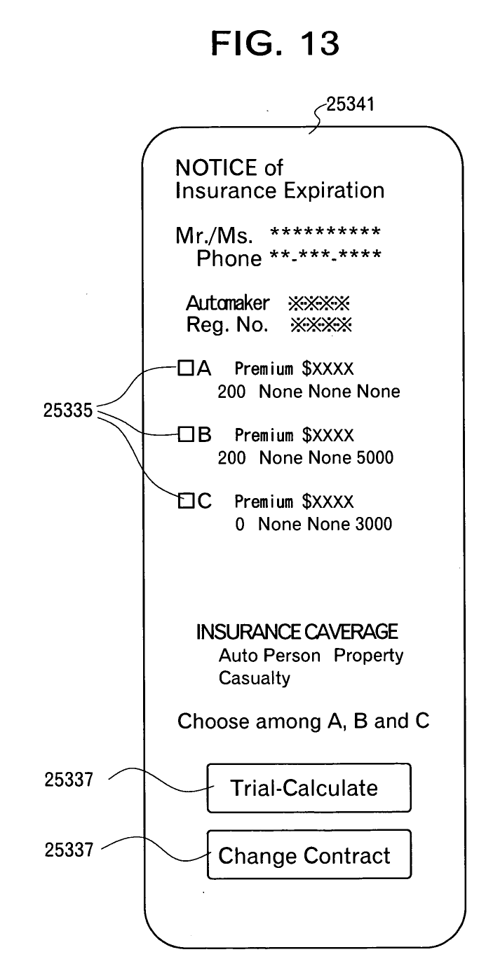

Subsequently, the management device 2 transmits the agent authentication information entry form to the corresponding terminal device 3 through the agent authentication support means 2112 (S104), and then, upon entering the ID number and password previously authenticated to the sales representative of the insurant agency, the entered data are submitted to the agent authentication information acquisition means 2113 of the management device 2 (S105-S106). Then, the terminal authentication information and agent authentication information are authenticated by the authentication means 212 of the management device 2 (S107). In this case, since the location authentication information is not recognized, but the terminal authentication information and agent authentication information are authenticated, the authentication level is determined as Level 1 by the level determination means 2122 (S108). Consequently, the menu 2511 is transmitted to the terminal device 3 through the service information means 251 (S109). On the menu 2511 as shown in FIG. 6, “Auto Insurance (renewal)” 25121 is selected and notified to the management device 2 (S110). Thereafter, various application data entry forms for preparing an application form for renewal contract of auto insurance in the management device 2 are transmitted from the application assist means 252 to the terminal device 3 (S111). The relevant application data entry form is displayed on the display of the terminal device to permit the sales representative or customer to enter the required information into the form in sequence, to submit the entered information to the management device 2 (S112) and to make up the required renewal contract application form 2541 as shown in FIG. 8 (S113). The renewal contract application form by way of example may be prepared by searching the expiration information database 2533 on the basis of the agent authentication information and transmitting a list of expiration information of the customer in the charge of the sales representative of the insurance agent to the terminal device 3. The list of expiration information on the display of the terminal device 3 contains the names 25332 of the customers each having the insurance policy close to the expiration as shown in FIG. 12. The sales representative searches within the list of expiration information 25331 to retrieve the target name of the customer now in the charge of the sales representative, and then, selects “Next” 25333, so that the notice of insurance expiration information 25334, which was already sent to the customer by mail or the like, is displayed on the display of the terminal device 3. On the display of the terminal device 3, three types of recommended insurance advice for renewal contract are displayed as shown in FIG. 13. When selecting “Modified Contract” 25336 on the display, other contract information is displayed instead of the contract information 25335. By selecting one of three types of the contract information upon changing the contract type and pressing “Trial-calculation” 25337, a command for trial calculation of insurance premium is submitted to the management device 2.

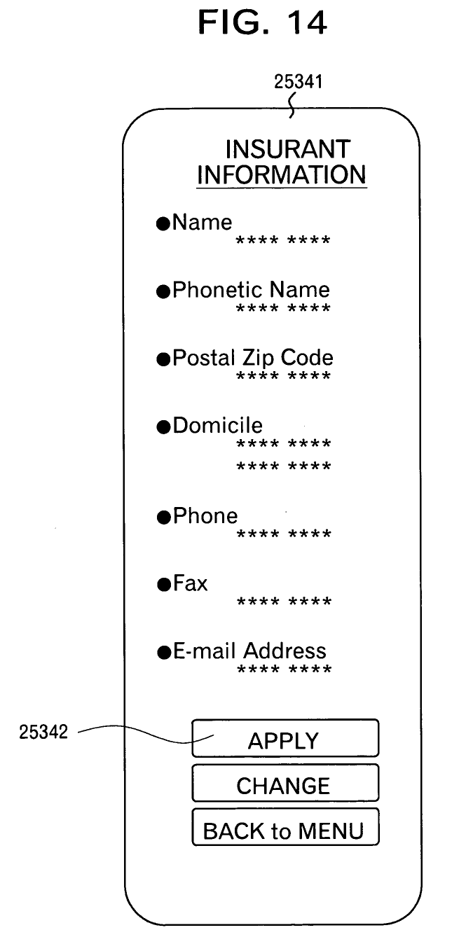

In the management device 2, the insurance premium for the newly contracted or renewal insurance is provisionally calculated referring to the premium trial-calculation database 2532, and then, the calculating result 25321 of the insurance premium is transmitted from the trial-calculation representation means to the terminal device 3. Thus, the calculating result 25321 is displayed on the display of the terminal device 3 as shown in FIG. 7. When the customer consents the contract conditions including the estimated insurance premium on the display of the terminal device, “Next” 25322 is selected to notify the customer's consents to the management device 2. In a case of requesting to change the contract conditions, save the trial calculating result or suspend the procedures, the requested form can be arbitrarily displayed. Next, the insurant information 25341 of the insurant registered beforehand in the insurant database 2534 is retrieved from the database with the insurant information transmission means 2327 of the management device 2. Upon confirming the insurant information 25341 thus retrieved and displayed on the display of the terminal device as shown in FIG. 14, “Apply” 25342 is selected to be transmitted to the management device 2. Then, an application form 2541 is made up with the application form drafting means 254 of the management device 2 on the basis of the contract policy selected at the terminal device 3 and the confirmed insurant information (S113). The subsequent procedures are the same as in that for the new insurance contract as described above (S114-S127). According to the working example 2 described above, since the agent authentication information and terminal authentication information can be transmitted to the management device by use of the terminal device owned by the sales representative of the insurance agent, insurance sales operation including procedure for entering into an insurance contract can be performed in quick response to any situation and convenience of the customer or insurant even outside the insurance agency office or business shop.

### Working Example 3

There will be described a working example 3 for browsing the insurance related information without submitting the terminal authentication information to the management device. In the diagrams of this embodiment, like components are denoted by the like numerical symbols.

Even when the sales representative of the insurance agent, who does not carry the terminal device, handheld mobile terminal or personal digital assistant (PDA) and/or dedicated adapter, meets the customer by coincidence and gets a chance to give an informed account to a customer outside the business office of the insurance agent, access to the management device 2 becomes available by using any computer possessed by the customer. For instance, when the sales representative of the insurance agent meets the customer and accesses to the Web site managed by the management device 2 through Internet by using an computer of an Internet cafe, the terminal authentication information is not submitted from such an unauthenticated terminal device to the management device 2 (S301).

In this case, the terminal authentication information as well is not submitted from the unauthenticated terminal device 3 to the management device 2, but the terminal discriminating information acquisition means 233 acquires the terminal discriminating information indicating that the terminal device 3 accessed to the management device is a common unauthenticated personal computer, in accordance with the kind or version of the browser installed on the unauthenticated personal computer (S302). The terminal discriminating information acquired by the management device 2 is collated with the terminal discriminating database 232, thus to determine how the information to be transmitted to the terminal device 3 is compensated through the information compensation means 231 (S103). The subsequent processing is carried out while compensating the information data to be transmitted from the management device 2 to the terminal device 3 in accordance with the displaying ability of the terminal device 3. The compensation appropriate for the cell phone serving as the terminal device is always performed every time the information data are transmitted to the terminal device. Subsequently, the agent authentication information entry form is transmitted from the agent authentication support means 2112 of the management device 2 to the corresponding terminal device 3 (S104). Then, by entering the ID code and password previously given to the insurance agent into the terminal device, the input data are submitted to the agent authentication information acquisition means 2113 of the management device 2 (S105-S106). Upon authenticating the agent authentication information with the authentication means 212 of the management device (S107), the authentication level of the terminal device is determined with the level determination means 2122 (S108). The authentication level in this case is determined as Level 2 based on Table 1 since only the agent authentication information is acquired, but the terminal authentication information and location authentication information are not acquired. Consequently, the menu 2511 is transmitted to the terminal device 3 through the service information means 251 (S109). On the menu 2511 as shown in FIG. 6, available services and unavailable services are distinguished by using different colors. In the case shown in FIG. 6, only “Trial Calculation” 25131 and “Phone Directory” 25141 are displayed as selectable items. By selecting one of the available services displayed on the terminal device from the menu 2511 (S110), the application assist means 252 is operated to assist browsing of the insurance-related information (S303). Thus, information data according to the available services are retrieved from the insurance-related information database 253 and displayed on the terminal device, simultaneously to provide an instruction form to ask for entering necessary data for disclosing requested information (S304). If the item “Trial Calculation” 25131 is selected as an example, a vehicle information entry form is transmitted to the terminal device 3, and then, upon entering the necessary data into the form on the terminal device 3, the entered vehicle information is submitted to the management device 2.

In response thereto, some recommended insurance advices appropriate to the vehicle information obtained by making reference to the insurance policy database 2531 are given to the terminal device 3 as a recommended insurance information notice. On the screen of the terminal device 3, three types of recommended insurance advices are displayed as the recommended insurance information notice as the customer chooses. The customer can make other choices than those displayed. By selecting any of three types of insurance contracts or changing the insurance contract, the management device 2 is asked for trial calculation of insurance premium. In response thereto, the management device 2 makes the trial calculation of the insurance premium for newly contracted or changed insurance the customer wishes, referring to the premium trial-calculation database 2532. Consequently, the trial-calculation result 25321 as shown in FIG. 7 is transmitted from the trial-calculation representation means to the terminal device 3 and displayed on the display of the terminal device 3. Although “Next” 25322 was selected in the working example 1, “Next” 25322 cannot be selected because of the contracting procedure of low authentication level in this working example 3, resulting in closing access to the insurance-related service. But, it is possible to save or print out the image of the trial-calculation result 25321 or transmit the same to the terminal device of the customer as circumstances demand. Thus, the insurance salesperson or sales representative of the insurance agent can make use of any terminal device at hand to instantaneously show the trial-calculation result of insurance premium to the customer and invite the customer to take out new or renewal insurance, consequently to improve the opportunity of insurance sales.

### INDUSTRIAL APPLICABILITY

As is apparent from the foregoing description, the insurance contract support system of the present invention can assist various routine clerical works for proceeding with the insurance contract by previously memorizing a variety of insurance-related information in the management device so as to transmitting the memorized information to the terminal device according to need. Therefore, since the insurance-related information need not be previously stored on the respective terminal devices, the information can easily be revised and changed timely by performing maintenance of the management device. Consequently, the insurance agency can get relief from cumbersome processing for maintaining or renewing various data and programs as installed in a dedicated terminal device of a conventional system, and therefore, devote to insurance sales as an insurance agent appointed by an insurance company. In a case of the insurance agency conducting insurance business on the side, the insurance agency can go about the insurance sales operation thereof without interfering the activities of sideline.

Furthermore, since the insurance contract support system can fitly compensate the information data to be transmitted from the management device to the terminal devices according to ability of each of the terminal devices of different types, various sets of information data need not be prepared previously for individual terminal devices, that is, one set of information data suffices for various types of terminal devices. Besides, even if the number of terminal devices to be managed by the management device, the system of the invention can cope with this without imposing any burdens on the management device.

Moreover, the system of the invention compensates the information to be given to the terminal device according to the displaying ability of the terminal device, so that the insurance-related information can be optimally received and displayed on either of a specified terminal device or unspecified terminal device effectively for insurance sales. That is, even if the insurance solicitor or agent does not carry an exclusive portable terminal device, which has been so far used, and/or sales papers such as insurance guide brochures at a time like this, he or she can effectively offer various insurance services to the customer by using his/her own terminal device at any time and any place, consequently to improve the opportunity of insurance sales.

Although there is fear that confidential information of the insurance company may possibly be exploited from the services, which are offered by the management device and can be available at any time and any place, high reliability and security of the system can be ensured by comprehending the situation of the connection between the management device and the terminal device and restricting the services depending on an authentication level determined according to the connection situation.

1. An insurance contract support system comprising a management device and a terminal device connected through a network,
said management device including:
an insurance-related information database storing insurance-related information,
a terminal discriminating information acquisition means for gaining information to discriminate said terminal device connected to said management device and specified or unspecified by said management device, and
an application assist means for issuing insurance-related information for making said management device available to said terminal device of any type in accordance with terminal discriminating information obtained by said terminal discriminating information acquisition means.

2. An insurance contract support system comprising a management device and a terminal device connected through a network,
said management device including:
an insurance-related information database storing insurance-related information,
a terminal discriminating information acquisition means for gaining information to discriminate said terminal device connected to said management device and specified or unspecified by said management device,
an information compensation means for compensating information to be given to said terminal device based on said terminal discriminating information from said terminal discriminating information acquisition means, and
an application assist means for issuing insurance-related information for making said management device available to said terminal device of any type in accordance with terminal discriminating information obtained by said terminal discriminating information acquisition means.

3. An insurance contract support system comprising a management device and a terminal device connected through a network,
said management device including:
an insurance-related information database storing insurance-related information,
a terminal discriminating information acquisition means for gaining information to discriminate said terminal device connected to said management device and specified or unspecified by said management device,
a terminal discriminating database storing said terminal discriminating information in correlation with displaying ability of description language of said terminal device,
an information compensation means for compensating information to be given to said terminal device by collating said terminal discriminating information from said terminal discriminating information acquisition means with said terminal discriminating information, and
an application assist means for issuing insurance-related information for making said management device available to said terminal device of any type in accordance with terminal discriminating information obtained by said terminal discriminating information acquisition means.

4. An insurance contract support system comprising a management device and a terminal device connected through a network,
said management device including:
an insurance-related information database storing insurance-related information,
a terminal discriminating information acquisition means for gaining information to discriminate said terminal device connected to said management device and specified or unspecified by said management device,
an information compensation means for compensating information to be given to said terminal device,
an application assist means for issuing insurance-related information for making said management device available to said terminal device of any type in accordance with terminal discriminating information obtained by said terminal discriminating information acquisition means, and
a contract conclusion means for concluding an insurance contract applied from said terminal device.

5. An insurance contract support system comprising a management device and a terminal device connected through a network,
said management device including:
an insurance-related information database storing insurance-related information,
a terminal discriminating information acquisition means for gaining information to discriminate said terminal device connected to said management device and specified or unspecified by said management device,
an information compensation means for compensating information to be given to said terminal device based on said terminal discriminating information from said terminal discriminating information acquisition means,
an application assist means for issuing insurance-related information for making said management device available to said terminal device of any type in accordance with terminal discriminating information obtained by said terminal discriminating information acquisition means, and
a contract conclusion means for concluding an insurance contract applied from said terminal device.

6. An insurance contract support system comprising a management device and a terminal device connected through a network,
said management device including:
an insurance-related information database storing insurance-related information,
a terminal discriminating information acquisition means for gaining information to discriminate said terminal device connected to said management device and specified or unspecified by said management device,
a terminal discriminating database storing said terminal discriminating information in correlation with displaying ability of description language of said terminal device,
an information compensation means for compensating information to be given to said terminal device by collating said terminal discriminating information from said terminal discriminating information acquisition means with said terminal discriminating information,
an application assist means for issuing insurance-related information for making said management device available to said terminal device of any type in accordance with terminal discriminating information obtained by said terminal discriminating information acquisition means, and
a contract conclusion means for concluding an insurance contract applied from said terminal device.

7. The insurance contract support system set forth in claim 1, wherein said management device further includes a connection information acquisition means for acquiring connection information indicative of connecting conditions between said management device and said terminal device, and an authentication means for authenticating said terminal device being accessed to said management device based on said connection information to determine an authentication level.

8. The insurance contract support system set forth in claim 7, wherein a sphere to assist an operation required for insurance contract is variable with said authentication level determined by the authentication means.

9. The insurance contract support system set forth in claim 7, wherein said connection information contain agent authentication information for distinguishing whether a user being accessed to said management device is authenticated or not.

10. The insurance contract support system set forth in claim 8, wherein said connection information contain agent authentication information for distinguishing whether a user being accessed to said management device is authenticated or not.

11. The insurance contract support system set forth in claim 7, wherein said connection information contain terminal authentication information for distinguishing whether said terminal device being accessed to said management device is authenticated or not.

12. The insurance contract support system set forth in claim 8, wherein said connection information contain terminal authentication information for distinguishing whether said terminal device being accessed to said management device is authenticated or not.

13. The insurance contract support system set forth in claim 9, wherein said connection information contain terminal authentication information for distinguishing whether said terminal device being accessed to said management device is authenticated or not.

14. The insurance contract support system set forth in claim 10, wherein said connection information contain terminal authentication information for distinguishing whether said terminal device being accessed to said management device is authenticated or not.

15. The insurance contract support system set forth in claim 7, wherein said connection information contain location authentication information for distinguishing whether a location from where said terminal device is accessed to said management device is authenticated or not.

16. The insurance contract support system set forth in claim 8, wherein said connection information contain location authentication information for distinguishing whether a location from where said terminal device is accessed to said management device is authenticated or not.

17. The insurance contract support system set forth in claim 9, wherein said connection information contain location authentication information for distinguishing whether a location from where said terminal device is accessed to said management device is authenticated or not.

18. The insurance contract support system set forth in claim 10, wherein said connection information contain location authentication information for distinguishing whether a location from where said terminal device is accessed to said management device is authenticated or not.

19. The insurance contract support system set forth in claim 11, wherein said connection information contain location authentication information for distinguishing whether a location from where said terminal device is accessed to said management device is authenticated or not.

20. The insurance contract support system set forth in claim 12, wherein said connection information contain location authentication information for distinguishing whether a location from where said terminal device is accessed to said management device is authenticated or not.

21. The insurance contract support system set forth in claim 13, wherein said connection information contain location authentication information for distinguishing whether a location from where said terminal device is accessed to said management device is authenticated or not.

22. The insurance contract support system set forth in claim 14, wherein said connection information contain location authentication information for distinguishing whether a location from where said terminal device is accessed to said management device is authenticated or not.

23. The insurance contract support system set forth in claim 9, wherein said application assist means is provided for assisting browsing of said insurance-related information with said terminal device having the agent authentication information acquired by said connection information acquisition means.

24. The insurance contract support system set forth in claim 10, wherein said application assist means is provided for assisting browsing of said insurance-related information with said terminal device having the agent authentication information acquired by said connection information acquisition means.

25. The insurance contract support system set forth in claim 11, wherein said application assist means is provided for assisting browsing of said insurance-related information with said terminal device having the agent authentication information acquired by said connection information acquisition means.

26. The insurance contract support system set forth in claim 12, wherein said application assist means is provided for assisting browsing of said insurance-related information with said terminal device having the agent authentication information acquired by said connection information acquisition means.

27. The insurance contract support system set forth in claim 13, wherein said application assist means is provided for assisting browsing of said insurance-related information with said terminal device having the agent authentication information acquired by said connection information acquisition means.

28. The insurance contract support system set forth in claim 14, wherein said application assist means is provided for assisting browsing of said insurance-related information with said terminal device having the agent authentication information acquired by said connection information acquisition means.

29. The insurance contract support system set forth in claim 15, wherein said application assist means is provided for assisting browsing of said insurance-related information with said terminal device having the agent authentication information acquired by said connection information acquisition means.

30. The insurance contract support system set forth in claim 16, wherein said application assist means is provided for assisting browsing of said insurance-related information with said terminal device having the agent authentication information acquired by said connection information acquisition means.

31. The insurance contract support system set forth in claim 25, wherein said application assist means assists routine clerical work of operating and concluding insurance contract when said connection information acquisition means acquires at least the agent authentication information and the terminal authentication information.

32. The insurance contract support system set forth in claim 26, wherein said application assist means assists routine clerical work of operating and concluding insurance contract when said connection information acquisition means acquires at least the agent authentication information and the terminal authentication information.

33. The insurance contract support system set forth in claim 29, wherein said application assist means assists routine clerical work of operating and concluding insurance contract when said connection information acquisition means acquires at least the agent authentication information and the terminal authentication information.

34. The insurance contract support system set forth in claim 30, wherein said application assist means assists routine clerical work of operating and concluding insurance contract when said connection information acquisition means acquires at least the agent authentication information and the terminal authentication information.

35. The insurance contract support system set forth in claim 1, wherein said insurance-related information database contains a plurality of pieces of insurance-related information in accordance with said available terminal devices so as to submit a corresponding one of pieces of insurance-related information to said terminal device based on said terminal discriminating information through said application assist means.

36. An insurance contract support system comprising a management device and a terminal device connected through a network,
said terminal device having a dedicated adapter connection means for permitting a dedicated adapter to automatically connect said terminal device to said management device for transmitting terminal authentication information assigned by an insurance company to said terminal device regardless of whether said terminal device is specified or unspecified, and
said management device including:
an insurance-related information database storing insurance-related information, and
an application assist means for issuing insurance-related information for making said management device available to said terminal device.

37. The insurance contract support system set forth in claim 2, wherein said management device further includes a connection information acquisition means for acquiring connection information indicative of connecting conditions between said management device and said terminal device, and an authentication means for authenticating said terminal device being accessed to said management device based on said connection information to determine an authentication level.

38. The insurance contract support system set forth in claim 3, wherein said management device further includes a connection information acquisition means for acquiring connection information indicative of connecting conditions between said management device and said terminal device, and an authentication means for authenticating said terminal device being accessed to said management device based on said connection information to determine an authentication level.

39. The insurance contract support system set forth in claim 4, wherein said management device further includes a connection information acquisition means for acquiring connection information indicative of connecting conditions between said management device and said terminal device, and an authentication means for authenticating said terminal device being accessed to said management device based on said connection information to determine an authentication level.

40. The insurance contract support system set forth in claim 5, wherein said management device further includes a connection information acquisition means for acquiring connection information indicative of connecting conditions between said management device and said terminal device, and an authentication means for authenticating said terminal device being accessed to said management device based on said connection information to determine an authentication level.

41. The insurance contract support system set forth in claim 6, wherein said management device further includes a connection information acquisition means for acquiring connection information indicative of connecting conditions between said management device and said terminal device, and an authentication means for authenticating said terminal device being accessed to said management device based on said connection information to determine an authentication level.
